(19) United States
(12) Patent Application Publication
(10) Pub. No.: US 2022/0135215 A1
(43) Pub. Date: May 5, 2022

(54) ZONED CONTACT BUSHING

(71) Applicant: Bell Textron Inc., Fort Worth, TX (US)

(72) Inventors: Andrew Ryan Maresh, Colleyville, TX (US); Robert P. Wardlaw, Keller, TX (US); Glenn Shimek, Kennedale, TX (US)

(21) Appl. No.: 17/089,131

(22) Filed: Nov. 4, 2020

(51) Int. Cl. B64C 27/48; B64C 27/10; F16C 11/04

(52) U.S. Cl. CPC B64C 27/48; F16C 2326/43; F16C 11/045; B64C 27/10

(57) ABSTRACT

There is disclosed in one example a mechanical assembly, including: a parent part including a parent part lug; a bushing to pass through the lug, the bushing comprising a central inner diameter, and respective left and right relief zones having a second inner diameter different from the central inner diameter; and a through-pin to pass through the bushing.

### TECHNICAL FIELD

This disclosure relates generally to aircraft devices and, more particularly, to a system and method of providing a zoned contact bushing.

### SUMMARY

In an example, there is disclosed a mechanical assembly, comprising: a parent part comprising a parent part lug; a bushing to pass through the lug, the bushing comprising a central inner diameter, and respective left and right relief zones having a second inner diameter different from the central inner diameter; and a through-pin to pass through the bushing.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates a side view of an example aircraft in accordance with certain embodiments of the present disclosure for a mechanism for implementing internal payload extension and retraction.

FIG. 2 illustrates a front plan view of the aircraft of FIG. 1 in which payload is retracted and stowed in payload bay.

FIG. 3 is a perspective view of selected portions of a rotor assembly.

FIG. 4 is a cutaway side view of a pin and lug assembly.

FIG. 5a is a cutaway side view of a bushing with edge relief zones.

FIG. 5b illustrates an alternative configuration where a crown bushing is provided.

FIGS. 6a-6b illustrate a parent part including a parent part lug.

FIGS. 7a-7b are a stress gauge illustration of the stresses that develop on a parent part lug.

FIGS. 8a-8b illustrate a common through-hole, through which a center pin passes.

FIGS. 9a-9b are a stress gauge illustration of the maximum stress zone for a parent part lug.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions may be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature) of an element, operations, and/or conditions, the phrase “between X and Y” represents a range that includes X and Y.

Further, as referred to herein in this Specification, the terms “forward,” “aft,” “inboard,” and “outboard” may be used to describe relative relationship(s) between components and/or spatial orientation of aspect(s) of a component or components. The term “forward” may refer to a special direction that is closer to a front of an aircraft relative to another component or component aspect(s). The term “aft” may refer to a special direction that is closer to a rear of an aircraft relative to another component or component aspect(s). The term “inboard” may refer to a location of a component that is within the fuselage of an aircraft and/or a spatial direction that is closer to or along a centerline of the aircraft relative to another component or component aspect(s), wherein the centerline runs in a between the front and the rear of the aircraft. The term “outboard” may refer to a location of a component that is outside the fuselage-of an aircraft and/or a special direction that farther from the centerline of the aircraft relative to another component or component aspect(s).

Still further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

A bushing is a sleeve-like mechanical member that is commonly used with a pin and a lug to rotatably secure a first piece to a second piece. For example, the lug may have a through-hole that is mechanically joined to a parent part, such as being integrally molded to the parent part. In an illustrative example, a second part may have dual lugs that also have through-holes, and that straddle the lug of the parent part. Sleeve-like bushings may be disposed within all three lugs, and may be relatively disposable wear parts that protect the lugs from excessive wear. A pin passes through all three lugs, and may be secured with an element such as a cotter pin, a nut, or some other securing means. With the pin passed through the lugs, the two parts may rotate relative to one another, placing wear on the bushings, with the lugs and their parent parts being substantially protected from mechanical wear.

Traditionally, a bushing has an outer diameter and a constant inner diameter drilled or machined through the center of the bushing. When the bushing takes load from a center pin, the center pin may experience some elastic deformation, particularly on its ends. The end loading and the elastic deformation of the pin means that often, the ends of the bushing take the brunt of the load. Elastic deformation is most pronounced during operation, when the greatest loads are present. This end loading of the bushing can cause very high stresses on the edge of the bushing, and on the edge portions of the parent part, which are to be protected by the bushing.

A bushing can be improved by providing an edge relief zone on the bushing. For example, drilling, machining, molding, or other mechanical processes may be used to create a bushing with an edge relief. The edge relief is a zone on the longitudinal ends of the bushing that has an inner diameter slightly greater than the inner diameter of the central or main portion of the bushing. Depending on the design parameters, this edge relief could be limited to particular symmetrical zones on opposite ends of the bushing, and the relief may taper gradually to the final relief diameter, or the relief may be stepped so that there is immediate transition from the lesser inner diameter to the greater inner diameter of the relief zone. Other examples are possible, including ones in which the relief is found only on a single end of the bushing (e.g., where greater stresses are experienced on one end or the other), or where the relief zones are non-symmetrical. Alternatively, there may a continuous taper from the center to the edge relief zones, where the continuous taper may be designed to conform to an expected elastic deformation of the pin, thereby more evenly distributing the load.

In the case of symmetrical edge relief zones on either end of the bushing, by machining in an edge relief to the bushing, the contact point of the pin can be controlled. This can ensure that the pin transfers a majority of the load to a selected point somewhat inward of the edge of the bushing. This can move the major stress points away from the edge of the hole of the primary part, and thus away from the stress concentration factor (Kt) associated with that whole edge. This can drastically reduce stresses on the parent part, particularly on the edges, which may be more susceptible to wear. This can extend the service life of the part without having to redesign the parent part, and without adding any weight to the parent part.

The same principle could be applied in an embodiment where it is desirable to concentrate stresses on the edges. For example, the edge relief zone could have an inner diameter that is less than the inner diameter of the central portion of the bushing. This would further focus stresses on the ends. This configuration could be useful, for example, in a shear pin, where it is desirable for the pin to shear at a certain stress.

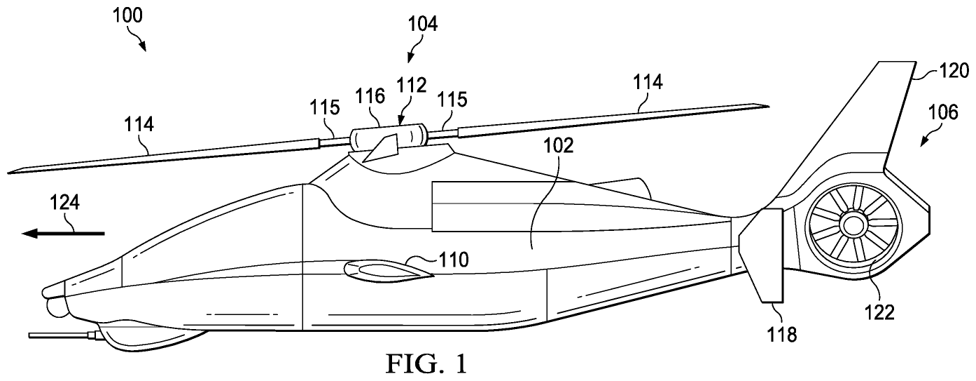

Referring to FIG. 1, illustrated therein is an example embodiment of an aircraft, which in the illustrated example is a rotorcraft 100. FIG. 1 portrays a side view of rotorcraft 100, which includes a fuselage 102, a primary rotor system 104, and an empennage 106. The fuselage 102 is the main body of the rotorcraft 100, which may include a cabin (e.g., for crew, passengers, and/or cargo) and/or may house certain mechanical components, electrical components, etc. (e.g., engine(s), transmission, flight controls, etc.). In accordance with features of embodiments described herein, the fuselage 102 also includes a payload bay covered by a payload bay door 108 disposed under a wing 110, which in some embodiments includes a support structure and actuation mechanism for extending externally stowed payload (e.g., weapons) outboard away from the fuselage 102 to a firing position. It will be recognized that, although not shown in the view illustrated in FIG. 1, the opposite side of the rotorcraft 100 also includes a wing and a payload bay door corresponding to the wing 110 and payload bay door 108.

The rotor system 104 is used to generate lift for rotorcraft 100. For example, the rotor system 104 (also generally referred to as the “rotor”) may include a rotor hub 112 (also referred to as a “rotor hub assembly” or more generally as a “hub”) coupled to a plurality of rotor blades 114 (also referred to generally as “blades”). Torque generated by the engine(s) of the rotorcraft causes the rotor blades 114 to rotate, which generates lift. The empennage 106 of the rotorcraft 100 includes a horizontal stabilizer 118, a vertical stabilizer 120, and a tail rotor or anti-torque system 122. Although not shown in the view illustrated in FIG. 1, a corresponding horizontal stabilizer is disposed on the other side of the rotorcraft 100 opposite the horizontal stabilizer 118. The horizontal stabilizer 118 and vertical stabilizer 120 respectively provide horizontal and vertical stability for the rotorcraft 100. Moreover, tail rotor or anti-torque system 122 may be used to provide anti-torque and/or direction control for the rotorcraft 100.

Rotorcraft 100 relies on rotor system 104 for flight capabilities, such as controlling (e.g., managing and/or adjusting) flight direction, thrust, and lift of the rotorcraft. For example, the pitch of each rotor blade 114 can be controlled using collective control or cyclic control to selectively control direction, thrust, and lift of the rotorcraft 100. During collective control, all the of rotor blades 114 are collectively pitched together (e.g., the pitch angle is the same for all blades), which effects overall thrust and lift. During cyclic control, the pitch angle of each of the rotor blades 114 varies depending on where each blade is within a cycle of rotation (e.g., at some points in the rotation the pitch angle is not the same for all blades), which can affect direction of travel of the rotorcraft 100.

Aircraft such as rotorcraft 100 can be subjected to various aerodynamic and operational forces during operation, such as lift, drag, centrifugal force, aerodynamic shears, and so forth. Lift and centrifugal force, for example, are forces produced by the rotation of a rotor system. Lift is an upward force that allows a rotorcraft to elevate, while centrifugal force is a lateral force that tends to pull the rotor blades outward from the rotor hub. These forces can subject the rotor hub, rotor yoke, and/or the rotor blades (referred to herein using the terms “hub/blades,” “yoke/blades,” “hub/yoke/blades,” and variations thereof) to flapping, leading and lagging, and/or bending. For example, flapping is a result of the dissymmetry of lift produced by rotor blades at different positions (typically referred to as “pitch” or “pitch angles”) during a single rotation. During rotation, for example, a rotor blade may generate more lift while advancing in the direction of travel of the rotorcraft than while retreating in the opposite direction. A rotor blade may be flapped up (also sometimes referred to as being pitched “nose-up”) while advancing in the direction of travel, and may flap down (e.g., pitched “nose-down”) while retreating in the opposite direction. When a blade is pitched more nose-up, more lift is created on that blade, which will drag the side of the rotor/hub upward, which makes the hub/yoke flap. For example, for rotorcraft 100, the most aft blade (e.g., nearest to tail rotor or anti-torque system 122) of the rotor system 104 may be pitched more nose-up and the most forward blade may be pitched more nose-down; to provide a forward direction of travel (as generally indicated by arrow 124) for rotorcraft 100.

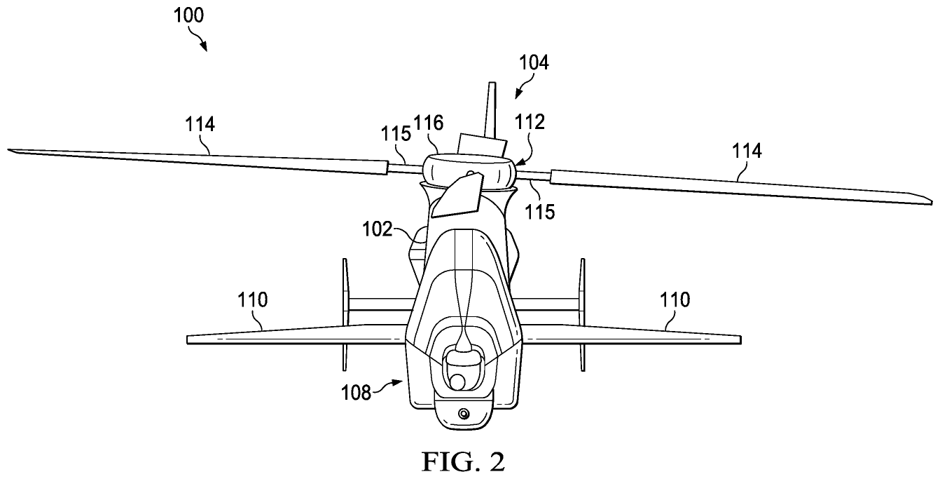

Referring now to FIG. 2, illustrated therein is a front plan view of rotorcraft 100 of FIG. 1. FIG. 2 illustrates rotorcraft 100 with payload bay doors 108 closed, wherein a payload is stowed within respective payload bays.

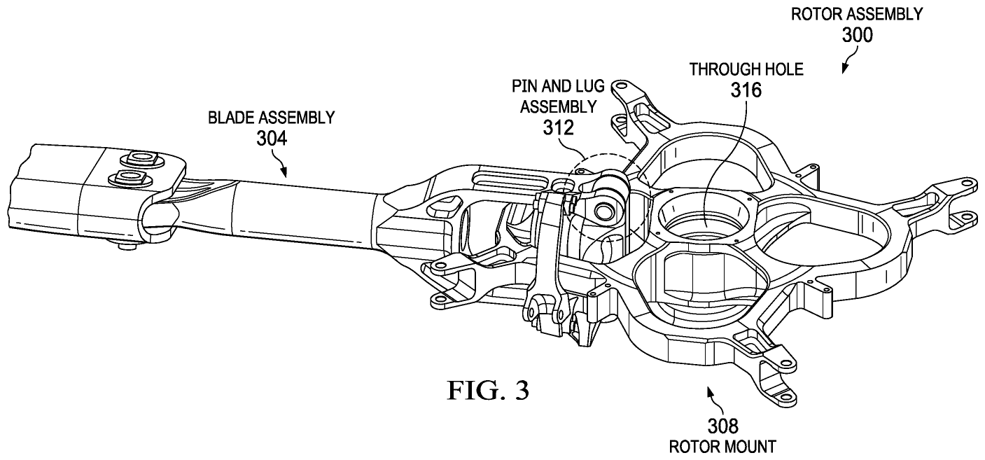

FIG. 3 is a perspective view of selected portions of a rotor assembly 300. In this case, rotor assembly 300 includes a rotor mount 308. Rotor mount 308 may include a through-hole 316 to receive a driveshaft. This imparts rotary motion to rotor assembly 300. Rotor assembly 300 also includes a rotor mount 308, which has through-hole 316, and is mechanically configured to receive blade assemblies, such as blade assembly 304. Blade assembly 304 mechanically couples a rotor blade, such as the rotors for rotary aircraft 100, to rotor mount 308. Blade assembly 304 is mechanically coupled to rotor mount 308 and is secured, at least in part, by a pin and lug assembly 312. Pin and lug assembly 312 includes rotor mount 308 as a parent part. Because rotor mount 308 is relatively expensive, and relatively difficult to replace, it is desirable to protect rotor mount 308 from excessive stress. Thus, in at least some embodiments, pin and lug assembly 312 may include a bushing to protect the parent part, which in this case is rotor mount 308. The bushing is a relatively disposable part compared to rotor mount 308, or to blade assembly 304.

However, as discussed above, in some cases a simple linear bushing with a uniform inner diameter may impart extra stresses to the lug portion of rotor mount 308, such as when there is flexing in the pin, which may concentrate stresses on the edges. This can cause undesirable wear on rotor mount 308. Thus, it may be desirable to design pin and lug assembly 312 to include a bushing with a zoned relief, rather than a uniform inner diameter.

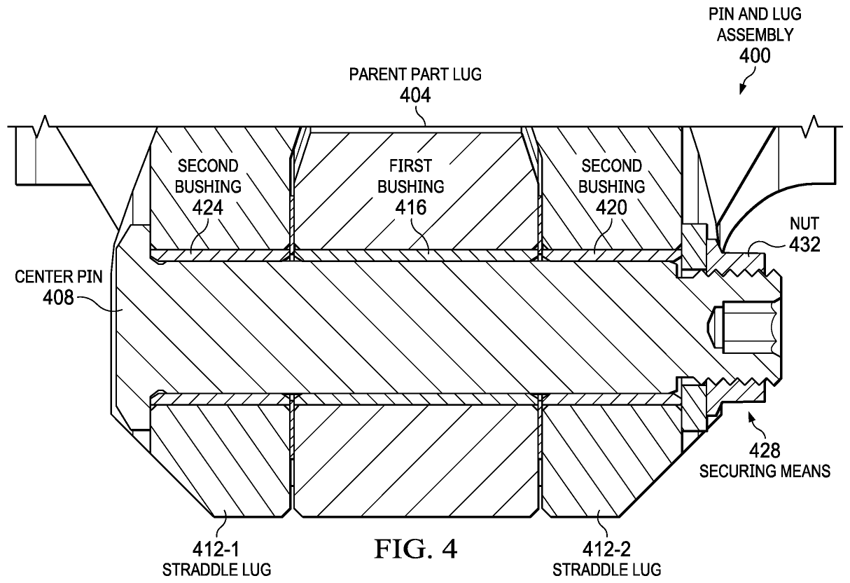

FIG. 4 is a cutaway side view of a pin and lug assembly 400. In this example, pin and lug assembly 400 includes a parent part lug 404, and a straddle lug 412 with two straddle lug members 412-1 and 412-2. Straddle lug 412 is mechanically configured to straddle or sit astride parent part lug 404, so that the three lug parts together form a common through-hole. A center pin 408 passes through the common through-hole of the three lugs, and may be secured by securing means 428. Securing means 428 could include a threading mechanism, such that center pin 408 threads into a nut 432. It could also include other securing means, such as a cotter pin or similar.

Three bushings are disposed within the common through-hole of the three lugs. This includes first bushing 416 (which sits within parent part lug 404), second bushing 424 (which sits within straddle lug 412-1), and third bushing 420 (which sits within straddle lug 412-2). Alternatively, a single bushing could replace all three bushings in other embodiments.

The stresses that develop on the lugs will depend on the type of bushing. For example, if the bushings are of a uniform inner diameter, then when center pin 408 flexes, stress may be concentrated on the ends of the respective bushings, which concentrate stress on the ends of the respective lugs.

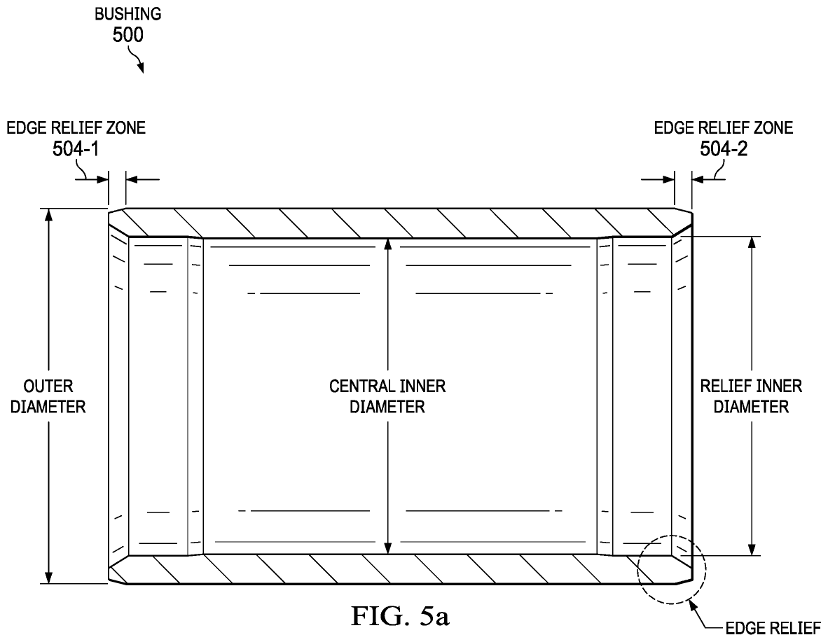

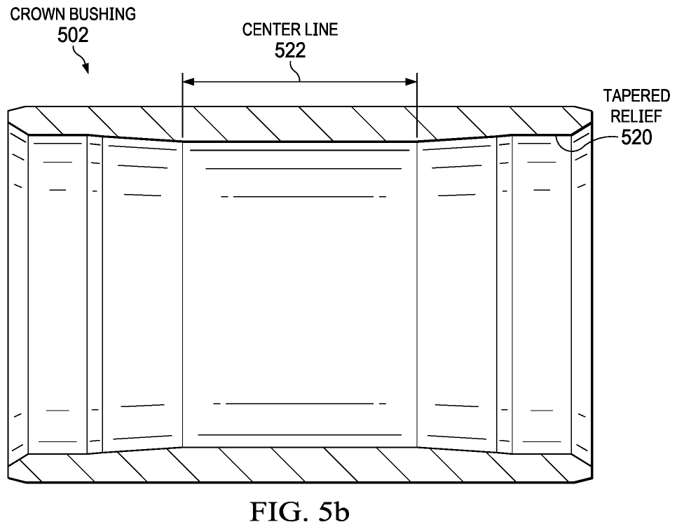

FIG. 5a is a cutaway side view of a bushing 500 with edge relief zones. Specifically, bushing 500 has an outer diameter and a central inner diameter, as illustrated. The central inner diameter is less than the outer diameter, thus forming a wall thickness for bushing 500. As discussed above, if central inner diameter is uniform throughout bushing 500, then stress will tend to develop at the edges of bushing 500. To alleviate this issue, and to concentrate stresses further inward of bushing 500, bushing 500 includes edge relief zones 504-1 and 504-2. Edge relief zones 504 may have a relief inner diameter that is greater than the central inner diameter. For example, in one illustrative embodiment, the outer diameter is 0.30 inches, the central inner diameter is 1.0 inches, and the relief inner diameter is 1.013 inches.

In this illustration, edge relief zones 504 are each approximately 10%-15% of the overall length of bushing 500 in a longitudinal direction. In other cases, the central inner diameter may occupy at least approximately half of the longitudinal length of bushing 500. In those cases, edge relief zones 504 may each be between approximately 10%-25% of the overall longitudinal length of bushing 500.

The configuration of FIG. 5a illustrates an example where edge relief zones 504 taper off sharply. Rather than tapering off, this could also be a step configuration, wherein there is a direct and immediate transition between the first inner diameter and the second inner diameter. This configuration provides a counterbore, wherein the counterbore may be machined, forged, or cast to provide the relief inner diameter.

Other embodiments are also possible, including an embodiment in which the edge relief is not a discrete zone, but rather one where the central inner diameter starts at or near the center of the bushing, and then tapers gradually to a relief inner diameter. In some cases, this gradual taper could be designed to conform to the expected flexing of the through-pin.

Furthermore, in this illustration, there is a gradual taper from the central inner diameter to the relief inner diameter within edge relief zones 504. In other cases, a stepped design could be used so that there is effectively an instant transition from the center inner diameter to the relief inner diameter.

FIG. 5b illustrates an alternative configuration where a crown bushing 502 is provided. Crown bushing 502 may lack a distinctive relief zone. In this illustration, crown bushing 502 has a centerline 522, which is a relatively smaller central portion with a uniform inner diameter. However, centerline 522 is optional, and in some embodiments of a crown bushing, there is no centerline with a continuous zone of consistent inner diameter.

In the case of crown bushing 502, a tapered relief 520 is provided. Tapered relief 520 tapers more gradually from the edges of centerline 522 to the edges of crown bushing 502. In some cases, this gradual tapering may be designed to conform with the expected deformation of the pin. This allows the center pin to deform more conformally with crown bushing 502. In some cases, the taper goes all the way from one edge of crown bushing 502 to the other, and centerline 522 is not a continuous zone, but rather an inflection point where the slope of the taper gradually changes and moves in the opposite direction.

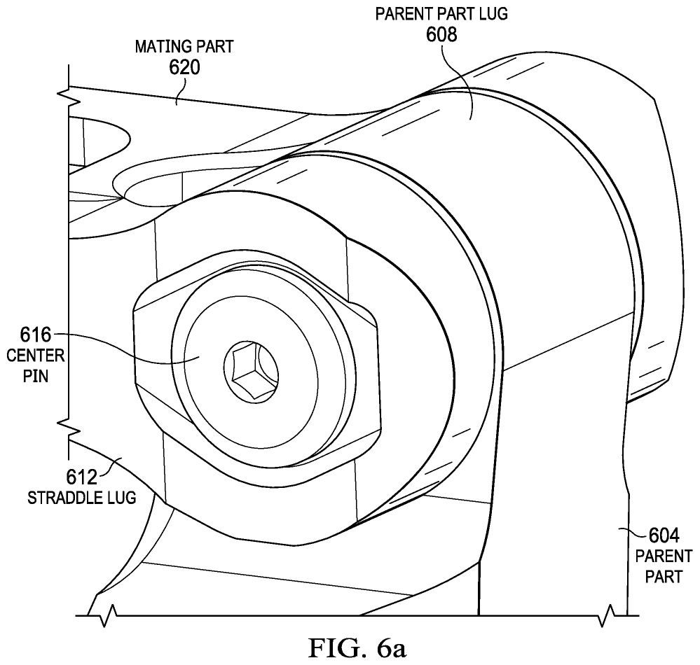

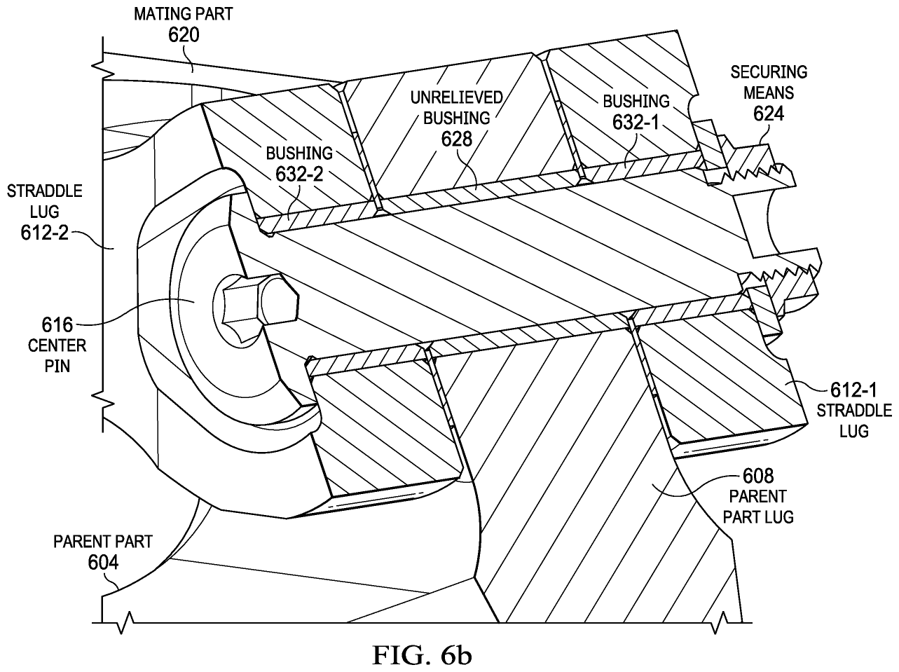

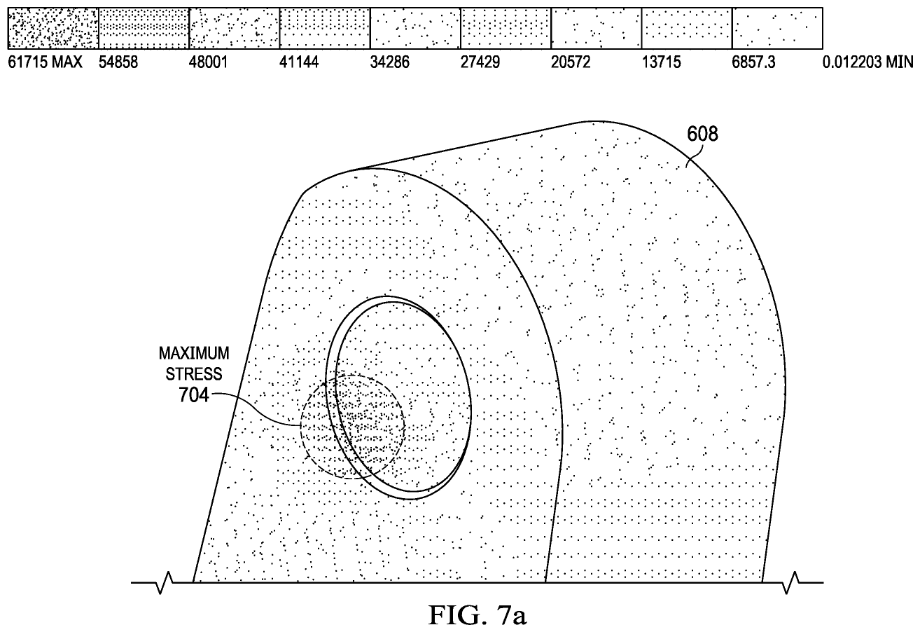

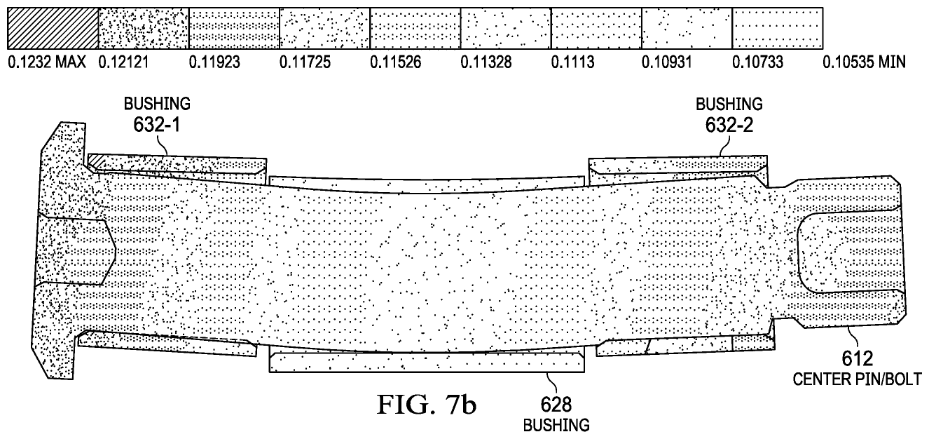

FIGS. 6a, 6b, 7a, and 7b illustrate an embodiment wherein at least some of the bushings use prior art designs with a uniform inner diameter. Optionally, this could be mixed with additional bushings that have edge relief zones, or other configurations.

In the example of FIG. 6a, a parent part 604 includes a parent part lug 608. A mating part 620 includes a straddle lug 612 that sits astride, or straddles, parent part lug 608. Straddle lug 612 and parent part lug 608 form a common through-hole, through which passes a center pin 616.

FIG. 6b is a cutaway perspective view of the configuration of FIG. 6a.

Illustrated in the cutaway are parent part 604, parent part lug 608, straddle lugs 612-1 and 612-2, and center pin 616. Center pin 616 secures with securing means 624, which as discussed above may be, for example, a threaded end with a nut, a cotter pin, or similar.

Three bushings are illustrated herein, namely bushing 632-1, bushing 632-2, and unrelieved bushing 628. Unrelieved bushing 628 may have a uniform inner diameter, as in the prior art. In this example, bushings 632-1 and 632-2 may have edge relief zones, or may be unrelieved bushings.

FIG. 7a is a stress gauge illustration of the stresses that develop on a parent part lug, in the case of an unrelieved bushing with a uniform inner diameter. In this example, parent part lug 608 receives the greatest stress at maximum stress zone 704. As shown, maximum stress zone 704 lies at or near the edge of parent part lug 608. This can cause parent part lug 608 to wear away more quickly as stress is concentrated on the edges, where part failure or degradation is more likely.

This is illustrated in FIG. 7b, where end bushings 628, 632-1, and 632-2 receive center pin or bolt 612. In this case, center pin 612 experiences flexing during operation, and the flexing causes deformation in center pin 612. This deformation concentrates stresses along the edges of bushing 628, which then imparts those stresses to the edges of a parent part, such as parent part lug 608.

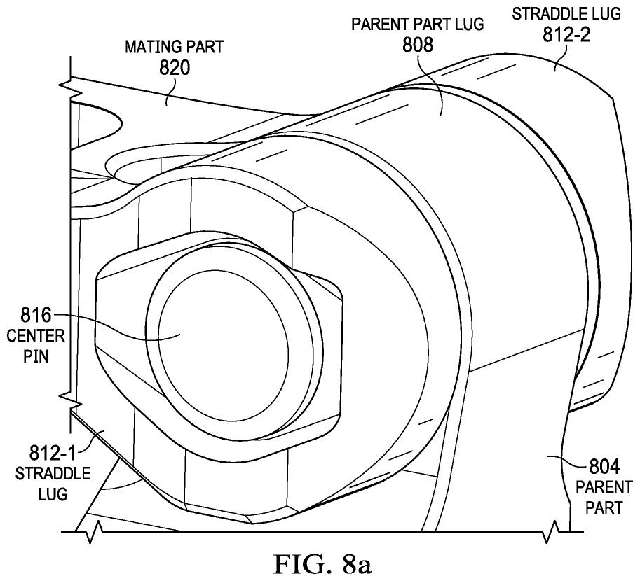

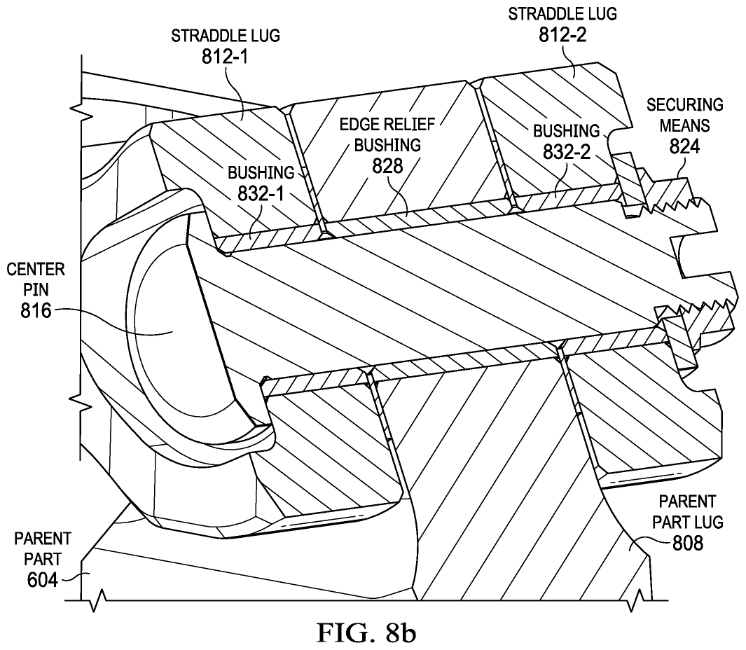

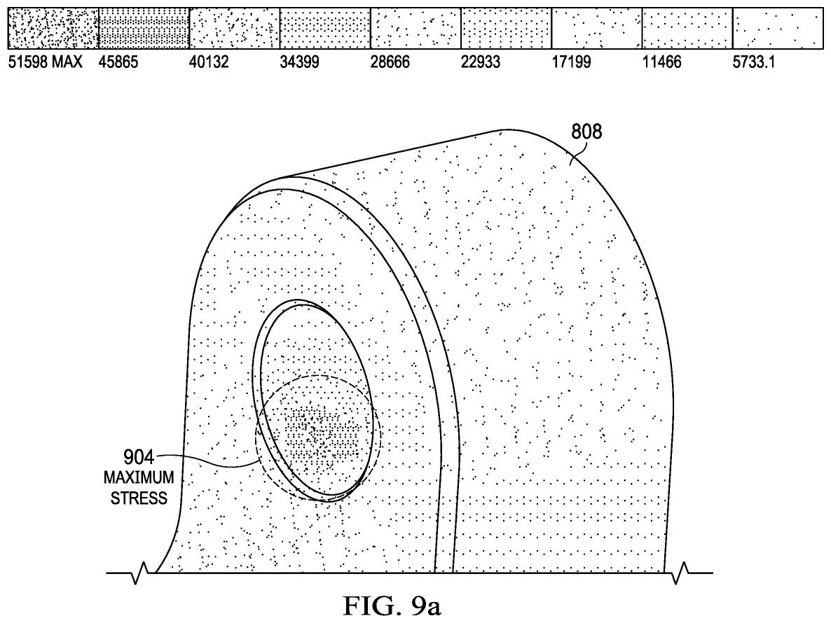

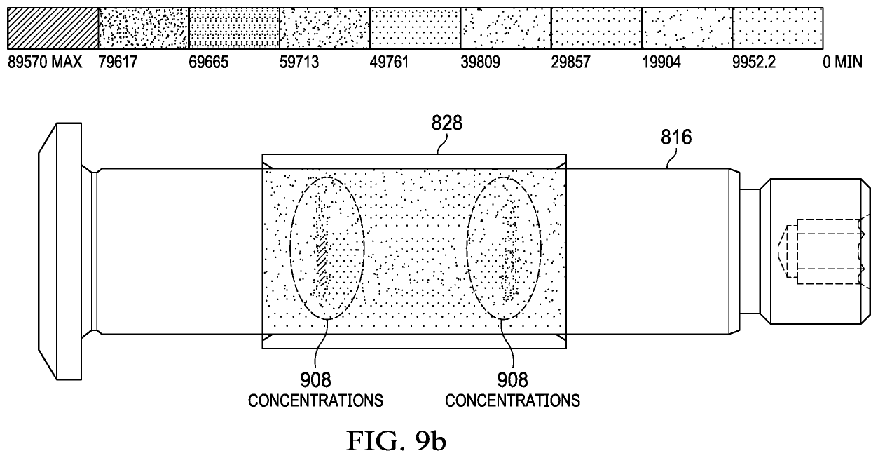

FIGS. 8a, 8b, 9a, and 9b illustrate an alternative embodiment in which a bushing with edge relief zones is used, instead of an unrelieved bushing.

In the example of FIG. 8a, parent part 804 and mating part 820 include parent part lug 808 and a straddle lug including straddle lug members 812-1 and 812-2. Lugs 812-1, 812-2, and 808 together form a common through-hole, through which a center pin 816 passes.

FIG. 8b is a cutaway perspective view of the same configuration as FIG. 8a. Illustrated here are parent part 804, parent part lug 808, straddle lugs 812-1 and 812-2, and center pin 816. Securing means 824 are also illustrated.

As before, three bushings are used, namely edge relief bushing 828, bushing 832-1, and bushing 832-2.

Edge relief bushing 828 may be a bushing that conforms, for example, to the design of bushing 500 of FIG. 5. This bushing includes edge relief zones, which are configured to provide clearance for a flexing center pin 816. This clearance helps to concentrate bushings not at the edges of parent part lug 808, but rather further inward of parent part lug 808.

This is illustrated in FIGS. 9a and 9b.

FIG. 9a is a stress gauge illustration. As can be seen in this illustration, the maximum stress zone for parent part lug 808 is not concentrated at the edges of parent part lug 808, but rather further inward. This maximum stress zone 904 is located in a position such that less wear and degradation is ultimately placed on parent part lug 808, which helps to increase the service life of the parent part.

As illustrated in FIG. 9b, when an edge relief bushing 828 is used, center pin 816 may still flex in the presence of operational loads. However, the edge relief zones of bushing 828 provide some clearance for the flexing of center pin 816. Thus, stress concentrations 908 develop inward on bushing 828, which therefore provide maximum stress zones 904 (FIG. 9a) that are located inward of parent part lug 808. Again, this helps to increase the service life of the parent part, and to move the maximum stress portions away from areas that are likely to develop greater degradation, or are more likely to lead to part failure. This can increase the service life of the parent part, which is relatively more expensive and difficult to replace, compared to bushing 828.

It will be recognized that different types/arrangements of doors, as described herein, provide different clearances to the payload and/or the ground and require different actuation systems. Additionally, different door arrangements involve different levels of complexity. For example, some require more rollers or moving parts. Some of the configurations enable the door to be closed after the weapons have been extended into the airstream. The decision to use one configuration versus another is dependent on the aircraft and its intended use, as well as the design space of cost, weight, complexity, and development time.

Additionally, it is possible to attach the section of the fuselage through which the payload sweeps to the munitions launcher itself. This configuration eliminates the complexity of a separate mechanism, but it drives loads and other interfaces into the munitions launcher and does not allow the door to be shut with the weapons extended from the fuselage. In such an embodiment, the fuselage panel would be mounted to the munitions launcher and would move out with it when extended. When retracted, the panel would seat against the fuselage frames and longerons at the top and bottom thereof.

Example 1 is a mechanical assembly, comprising: a parent part comprising a parent part lug; a bushing to pass through the lug, the bushing comprising a central inner diameter, and respective left and right relief zones having a second inner diameter different from the central inner diameter; and a through-pin to pass through the bushing.

Example 2 is a mechanical assembly, wherein the second inner diameter is greater than the central inner diameter.

Example 3 is a mechanical assembly, wherein the second inner diameter is less than the central inner diameter.

Example 4 is a mechanical assembly, further comprising a mating part having second and third lugs to straddle the parent part lug, and second and third bushings to pass through the second and third lugs.

Example 5 is a mechanical assembly, wherein the second and third bushings have substantially uniform inner diameters.

Example 6 is a mechanical assembly, wherein the substantially uniform inner diameters are substantially the central inner diameter.

Example 7 is a mechanical assembly, wherein the central inner diameter is a diameter of a central inner wall.

Example 8 is a mechanical assembly, wherein the second inner diameter is symmetrically disposed around the central inner diameter.

Example 9 is a mechanical assembly, wherein an inner wall comprises three zones including a first center zone of the central inner diameter, and second and third zones disposed on laterally opposite sides of the first zone and having the second inner diameter.

Example 10 is a mechanical assembly, wherein the central inner diameter tapers to the second inner diameter.

Example 11 is a mechanical assembly, wherein an inner wall of the bushing comprises a center zone of the central inner diameter, the center zone occupying at least half of a longitudinal cross-sectional area of the bushing, and wherein the left and right relief zones are disposed on opposite sides of the center zone and have the second inner diameter.

Example 12 is a mechanical assembly, wherein the center zone tapers to the left and right relief zones.

Example 13 is a mechanical assembly, wherein the center zone transitions to the left and right relief zones without tapering.

Example 14 is a rotor blade assembly for a rotary aircraft comprising the mechanical assembly of any of examples 1-13.

Example 15 is a rotary aircraft comprising the rotor blade assembly of example 14.

Example 16 is a zoned contact bushing, comprising a substantially uniform outer diameter, a first inner diameter, and a second inner diameter, wherein the first inner diameter is less than the second inner diameter.

Example 17 is a zoned contact bushing, wherein the first inner diameter is a diameter of a central inner wall.

Example 18 is a zoned contact bushing, wherein the second inner diameter is symmetrically disposed around the first inner diameter.

Example 19 is a zoned contact bushing, wherein an inner wall comprises three zones including a first center zone of the first inner diameter, and second and third zones disposed on laterally opposite sides of the first zone and having the second inner diameter.

Example 20 is a zoned contact bushing, wherein the first inner diameter tapers to the second inner diameter.

Example 21 is a zoned contact bushing, wherein an inner wall of the bushing comprises a center zone of the first inner diameter, the center zone occupying at least half of a longitudinal cross-sectional area of the bushing, and left and right relief zones disposed on opposite sides of the center zone and having the second inner diameter.

Example 22 is a zoned contact bushing, wherein the center zone tapers to the left and right relief zones.

Example 23 is a zoned contact bushing, wherein the center zone transitions to the left and right relief zones without tapering.

Example 24 is a parent part assembly comprising the zoned contact bushing of any of examples 16-23.

Example 25 is a parent part assembly, wherein the parent part assembly is integrated with a zoned contact bushing.

Example 26 is a rotary aircraft, comprising: an airframe; an engine; a drive system; and a rotor assembly comprising a blade assembly joined to a rotor mount with a pin assembly, comprising a first lug integrated with the rotor mount, second and third lugs integrated with the blade assembly and disposed astride the first lug, first, second, and third bushings passed through the first, second, and third lugs respectively, and a secured pin passed through the first, second, and third bushings; wherein the first bushing has a central inner diameter occupying at least half of the first bushing as measured along a long axis, and symmetrical edge relief zones disposed on opposite sides of the central inner diameter.

Example 27 is a rotary aircraft, wherein a second inner diameter of the first bushing is greater than the central inner diameter.

Example 28 is a rotary aircraft, wherein a second inner diameter of the first bushing is less than the central inner diameter.

Example 29 is a rotary aircraft, further comprising a mating part wherein the second and third lugs straddle a parent part lug, and the second and third bushings pass through the second and third lugs.

Example 30 is a rotary aircraft, wherein the second and third bushings have substantially uniform inner diameters.

Example 31 is a rotary aircraft, wherein the substantially uniform inner diameters are substantially the central inner diameter.

Example 32 is a rotary aircraft, wherein the central inner diameter is a diameter of a central inner wall.

Example 33 is a rotary aircraft, wherein a second inner diameter is symmetrically disposed around the central inner diameter.

Example 34 is a rotary aircraft, wherein an inner wall comprises three zones including a first center zone of the central inner diameter, and second and third zones disposed on laterally opposite sides of the first zone and having a second inner diameter.

Example 35 is a rotary aircraft, wherein the central inner diameter tapers to a second inner diameter.

Example 36 is a rotary aircraft, wherein an inner wall of the bushing comprises a center zone of the central inner diameter, the center zone occupying at least half of a longitudinal cross-sectional area of the bushing, and wherein the symmetrical edge relief zones have a second inner diameter.

Example 37 is a rotary aircraft, wherein the center zone tapers to the symmetrical edge relief zones.

Example 38 is a rotary aircraft, wherein the center zone transitions to the symmetrical edge relief zones without tapering.

Example 39 is a rotary aircraft of any of examples 26-38, wherein the rotary aircraft is an attack helicopter.

Example 40 is a rotor blade assembly for the rotary aircraft of any of examples 26-38.

The diagrams in the FIGURES illustrate the architecture, functionality, and operation of possible implementations of various embodiments of the present disclosure. It should also be noted that, in some alternative implementations, the function(s) associated with a particular block may occur out of the order specified in the FIGURES. For example, two blocks shown in succession may, in fact, be executed substantially concurrently, or the blocks may sometimes be executed in the reverse order or alternative orders, depending upon the functionality involved.

The embodiments described throughout this disclosure provide numerous technical advantages, including by way of example, maintaining performance at high angles of attack while increasing performance at low angles of attack.

Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment,” “example embodiment,” “an embodiment,” “another embodiment,” “certain embodiments,” “some embodiments,” “various embodiments,” “other embodiments,” “alternative embodiment,” and the like are intended to mean that any such features are included in one or more embodiments of the present disclosure, but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z,” “at least one of X, Y or Z,” “one or more of X, Y and Z,” “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., element, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A mechanical assembly, comprising:
a parent part comprising a parent part lug;
a bushing to pass through the lug, the bushing comprising a central inner diameter, and respective left and right relief zones having a second inner diameter different from the central inner diameter; and
a through-pin to pass through the bushing.

2. The mechanical assembly of claim 1, wherein the second inner diameter is greater than the central inner diameter.

3. The mechanical assembly of claim 1, wherein the second inner diameter is less than the central inner diameter.

4. The mechanical assembly of claim 1, further comprising a mating part having second and third lugs to straddle the parent part lug, and second and third bushings to pass through the second and third lugs.

5. The mechanical assembly of claim 4, wherein the second and third bushings have substantially uniform inner diameters.

6. The mechanical assembly of claim 5, wherein the substantially uniform inner diameters are substantially the central inner diameter.

7. The mechanical assembly of claim 1, wherein the central inner diameter is a diameter of a central inner wall.

8. The mechanical assembly of claim 1, wherein the second inner diameter is symmetrically disposed around the central inner diameter.

9. The mechanical assembly of claim 1, wherein an inner wall comprises three zones including a first center zone of the central inner diameter, and second and third zones disposed on laterally opposite sides of the first zone and having the second inner diameter.

10. The mechanical assembly of claim 1, wherein the central inner diameter tapers to the second inner diameter.

11. The mechanical assembly of claim 1, wherein an inner wall of the bushing comprises a center zone of the central inner diameter, the center zone occupying at least half of a longitudinal cross-sectional area of the bushing, and wherein the left and right relief zones are disposed on opposite sides of the center zone and have the second inner diameter.

12. The mechanical assembly of claim 11, wherein the center zone tapers to the left and right relief zones.

13. The mechanical assembly of claim 11, wherein the center zone transitions to the left and right relief zones without tapering.

14. A zoned contact bushing, comprising a substantially uniform outer diameter, a first inner diameter, and a second inner diameter, wherein the first inner diameter is less than the second inner diameter.

15. The zoned contact bushing of claim 14, wherein an inner wall comprises three zones including a first center zone of the first inner diameter, and second and third zones disposed on laterally opposite sides of the first zone and having the second inner diameter.

16. The zoned contact bushing of claim 14, wherein the first inner diameter tapers to the second inner diameter.

17. The zoned contact bushing of claim 14, wherein an inner wall of the bushing comprises a center zone of the first inner diameter, the center zone occupying at least half of a longitudinal cross-sectional area of the bushing, and left and right relief zones disposed on opposite sides of the center zone and having the second inner diameter.

18. A rotary aircraft, comprising:
an airframe;
an engine;
a drive system; and
a rotor assembly comprising a blade assembly joined to a rotor mount with a pin assembly, comprising a first lug integrated with the rotor mount, second and third lugs integrated with the blade assembly and disposed astride the first lug, first, second, and third bushings passed through the first, second, and third lugs respectively, and a secured pin passed through the first, second, and third bushings;
wherein the first bushing has a central inner diameter occupying at least half of the first bushing as measured along a long axis, and symmetrical edge relief zones disposed on opposite sides of the central inner diameter.

19. The rotary aircraft of claim 18, wherein a second inner diameter of the first bushing is greater than the central inner diameter.

20. The rotary aircraft of claim 18, wherein a second inner diameter of the first bushing is less than the central inner diameter.

21. The rotary aircraft of claim 18, further comprising a mating part wherein the second and third lugs straddle a parent part lug, and the second and third bushings pass through the second and third lugs.

22. The rotary aircraft of claim 21, wherein the second and third bushings have substantially uniform inner diameters.
